(19) United States
(12) Patent Application Publication
(10) Pub. No.: US 2025/0219693 A1
(43) Pub. Date: Jul. 3, 2025

(54) TERMINAL, RADIO COMMUNICATION METHOD, AND BASE STATION

(71) Applicant: NTT DOCOMO, INC., Tokyo (JP)

(72) Inventors: Haruhi Echigo, Tokyo (JP); Hiroki Harada, Tokyo (JP); Qiping Pi, Beijing (CN); Jing Wang, Beijing (CN); Lan Chen, Beijing (CN)

(73) Assignee: NTT DOCOMO, INC., Tokyo (JP)

(21) Appl. No.: 18/835,187

(22) PCT Filed: Feb. 8, 2022
(86) PCT No.: PCT/JP2022/004886

§ 371 Date: Aug. 1, 2024

(51) Int. Cl. H04B 7/06; H04W 72/231; H04W 72/51

(52) U.S. Cl. CPC H04B 7/0626; H04W 72/231; H04W 72/51

(57) ABSTRACT

A terminal according to one aspect of the present disclosure includes a receiving section that receives information related to a parameter to be applied to a report of encoded channel state information (CSI), and a control section that controls the report of the encoded CSI, based on the information related to the parameter.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

Regarding future radio communication technology, utilizing artificial intelligence (AI) technology such as machine learning (ML) for control, management, and the like of a network/device has been under study. For example, regarding future radio communication technology, utilizing AI technology for enhancement of channel state information (Channel State Information Reference Signal (CSI)) feedback, such as overhead reduction, accuracy improvement, and prediction, has been under study. The CSI feedback based on AI technology may be referred to as AI-aided CSI feedback or auto-encoded CSI reporting.

However, studies on specific details of the AI-aided CSI feedback have not yet been carried out. Unless these are appropriately defined, appropriate overhead reduction/high-accuracy channel estimation/high-efficiency use of resources cannot be achieved, which may hinder enhancement of communication throughput/communication quality.

In view of this, the present disclosure has one object to provide a terminal, a radio communication method, and a base station that can appropriately implement feedback/report of channel state information in future radio communication systems.

### Solution to Problem

A terminal according to one aspect of the present disclosure includes a receiving section that receives information related to a parameter to be applied to a report of encoded channel state information (CSI), and a control section that controls the report of the encoded CSI, based on the information related to the parameter.

### Advantageous Effects of Invention

According to one aspect of the present disclosure, feedback/report of channel state information can be appropriately implemented in future radio communication systems.

### BRIEF DESCRIPTION OF DRAWINGS

FIG. 1 is a diagram to show an example of a CSI report setting/resource settings.

FIG. 2 is a diagram to show an example of association between the CSI report settings and the resource settings.

FIG. 3 is a diagram to show an example of a method of indicating a CSI report using CSI trigger states.

FIGS. 4A and 4B are diagrams to show examples of flowcharts for generating CSI feedback when one or more trained models are configured in advance.

FIG. 5 is a diagram to show an example of a flowchart for generating the CSI feedback when a base station trains a model.

FIG. 6 is a diagram to show an example of a flowchart for generating the CSI feedback when a UE trains a model.

FIG. 7 is a diagram to show an example of the CSI feedback using an encoder/decoder in the present disclosure.

FIG. 8 is a diagram to show an example of the CSI feedback using an encoder/decoder in which quantization in the present disclosure is introduced.

FIG. 9 is a diagram to show an example of a case in which information related to an indication of a report of encoded CSI/PMI is included in a certain higher layer parameter (report quantity).

FIG. 10 is a diagram to show an example of a case in which information related to an indication of a report of encoded CSI/PMI is included in a certain higher layer parameter (codebook type).

FIG. 11 is a diagram to show an example of a case in which information of encoded CSI feedback related parameters are included in the certain higher layer parameter (report quantity).

FIG. 12 is a diagram to show an example of a case in which information of encoded CSI feedback related parameters are included in the certain higher layer parameter (CSI trigger state).

FIG. 13 is a diagram to show an example of a schematic structure of a radio communication system according to one embodiment.

FIG. 14 is a diagram to show an example of a structure of a base station according to one embodiment.

FIG. 15 is a diagram to show an example of a structure of a user terminal according to one embodiment.

FIG. 16 is a diagram to show an example of a hardware structure of the base station and the user terminal according to one embodiment.

FIG. 17 is a diagram to show an example of a vehicle according to one embodiment.

### DESCRIPTION OF EMBODIMENTS

### (CSI Report (or Reporting))

In Rel-15/16 NR, a terminal (also referred to as a user terminal, a User Equipment (UE), and the like) generates (also referred to as determines, calculates, estimates, measures, and the like) channel state information (CSI), based on a reference signal (RS) (or a resource for the RS), and transmits (also referred to as reports, feeds back, and the like) the generated CSI to a network (for example, a base station). The CSI may be transmitted to the base station by using an uplink control channel (for example, a Physical Uplink Control Channel (PUCCH)) or an uplink shared channel (for example, Physical Uplink Shared Channel (PUSCH)), for example.

The RS used for the generation of the CSI may be at least one of a channel state information reference signal (CSI-RS), a synchronization signal/broadcast channel (Synchronization Signal/Physical Broadcast Channel (SS/PBCH)) block, a synchronization signal (SS), a demodulation reference signal (DMRS), and the like, for example.

The CSI-RS may include at least one of a non zero power (NZP) CSI-RS and CSI-Interference Management (CSI-IM). The SS/PBCH block is a block including the SS and the PBCH (and a corresponding DMRS), and may be referred to as an SS block (SSB) or the like. The SS may include at least one of a primary synchronization signal (PSS) and a secondary synchronization signal (SSS).

Note that the CSI may include at least one of a channel quality indicator (CQI), a precoding matrix indicator (PMI), a CSI-RS resource indicator (CRI), an SS/PBCH block resource indicator (SSBRI), a layer indicator (LI), a rank indicator (RI), L1-RSRP (reference signal received power in Layer 1 (Layer 1 Reference Signal Received Power)), L1-RSRQ (Reference Signal Received Quality), an L1-SINR (Signal to Interference plus Noise Ratio), an L1-SNR (Signal to Noise Ratio), and the like.

The UE may receive information (report configuration information) related to a CSI report, and control the CSI report, based on the report configuration information. The report configuration information may be, for example, a radio resource control (RRC) information element (IE) “CSI-ReportConfig”. Note that, in the present disclosure, the RRC IE may be interchangeably interpreted as an RRC parameter, a higher layer parameter, and the like.

The report configuration information (for example, the RRC IE “CSI-ReportConfig”) may include at least one of the following, for example.
Information (report type information, for example, an RRC IE “reportConfigType”) related to a type of the CSI report
Information (report quantity information, for example, an RRC IE “reportQuantity”) related to one or more quantities (one or more CSI parameters) of the CSI to be reported
Information (resource information, for example, an RRC IE “CSI-ResourceConfigId”) related to the resource for the RS used for generation of the quantity (the CSI parameter)
Information (frequency domain information, for example, an RRC IE “reportFreqConfiguration”) related to the frequency domain being a target of the CSI report

For example, the report type information may indicate a periodic CSI (P-CSI) report, an aperiodic CSI (A-CSI) report, or a semi-persistent CSI report (Semi-Persistent CSI (SP-CSI)) report.

The report quantity information may indicate at least one combination of the CSI parameters (for example, the CRI, the RI, the PMI, the CQI, the LI, the L1-RSRP, and the like).

The resource information may be an ID of the resource for the RS. The resource for the RS may include, for example, a non zero power CSI-RS resource or SSB, and a CSI-IM resource (for example, a zero power CSI-RS resource).

The frequency domain information may indicate frequency granularity of the CSI report. The frequency granularity may include, for example, a wideband and a subband. The wideband is the entire CSI reporting band. The wideband may be, for example, an entire certain carrier (component carrier (CC), cell, serving cell), or may be an entire bandwidth part (BWP) in a certain carrier. The wideband may be interpreted as CSI reporting band, the entire CSI reporting band, and the like.

The subband may be part of the wideband and constituted of one or more resource blocks (RBs or physical resource blocks (PRBs)). The size of the subband may be determined according to the size of the BWP (the number of PRBs).

The frequency domain information may indicate which of the PMI of the wideband or of the subband is to be reported (the frequency domain information may include, for example, an RRC IE “pmi-Format Indicator” used for determining any of a wideband PMI report and a subband PMI report). The UE may determine frequency granularity of the CSI report (that is, any of the wideband PMI report and the subband PMI report), based on at least one of the report quantity information and the frequency domain information.

When the wideband PMI report is configured (determined), one wideband PMI may be reported for the entire CSI reporting band. In contrast, when the subband PMI report is configured, a single wideband indication i₁ is reported for the entire CSI reporting band, and subband indication (one subband indication) i₂ of each of one or more subbands (for example, the subband indication of each subband) in the entire CSI report may be reported.

The UE performs channel estimation by using a received RS, and estimates a channel matrix H. The UE feeds back an index (PMI) that is determined based on the estimated channel matrix.

The PMI may indicate a precoder matrix (also simply referred to as a precoder) that the UE considers appropriate for the use for downlink (DL) transmission to the UE. Each value of the PMI may correspond to one precoder matrix. A set of values of the PMI may correspond to a different set of precoder matrices referred to as a precoder codebook (also simply referred to as a codebook).

In the space domain, the CSI report may include one or more types of CSI. For example, the CSI may include at least one of a first type (type 1 CSI) that is used for selection of a single beam and a second type (type 2 CSI) that is used for selection of a multi-beam. The single beam may be interpreted as a single layer, and the multi-beam may be interpreted as a plurality of beams. The type 1 CSI may not assume multi-user multiple input multiple output (MIMO), and the type 2 CSI may assume multi-user MIMO.

The codebook may include a codebook for the type 1 CSI (also referred to as a type 1 codebook or the like) and a codebook for the type 2 CSI (also referred to as a type 2 codebook or the like). The type 1 CSI may include type 1 single panel CSI and type 1 multi-panel CSI, and different codebooks (type 1 single panel codebook, type 1 multi-panel codebook) may be respectively defined.

In the present disclosure, Type 1 and Type I may be interchangeably interpreted. In the present disclosure, Type 2 and Type II may be interchangeably interpreted.

Uplink control information (UCI) types may include at least one of a Hybrid Automatic Repeat reQuest ACKnowledgement (HARQ-ACK), a scheduling request (SR), and CSI. The UCI may be carried on the PUCCH, or may be carried on the PUSCH.

In Rel-15/16 NR, the UCI can include one CSI part for wideband PMI feedback. CSI report #n includes PMI wideband information if being reported.

In Rel-15/16 NR, the UCI can include two CSI parts for subband PMI feedback. CSI part 1 includes wideband PMI information. CSI part 2 includes one piece of wideband PMI information and some pieces of subband PMI information (some subband PMI information). The CSI part 1 and the CSI part 2 are separately coded.

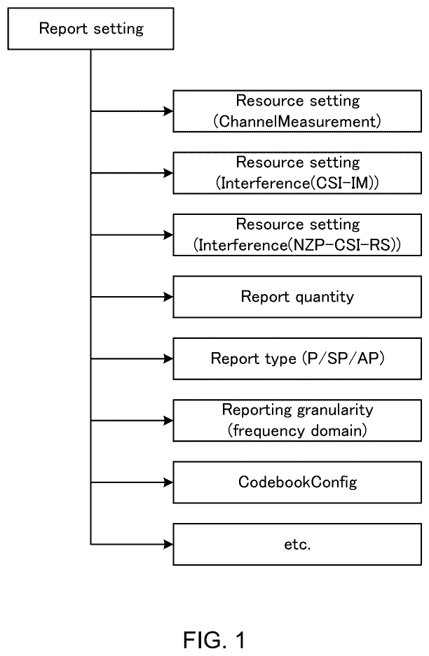

In Rel-15/16 NR, the UE is configured with report setting of N (N≥1) CSI report configurations and resource setting of M (M≥1) CSI resource configurations by a higher layer. For example, the CSI report configuration (CSI-ReportConfig) includes resource setting for channel measurement (resourcesForChannelMeasurement), CSI-IM resource setting for interference (csi-IM-ResourceForInterference), NZP-CSI-RS setting for interference (nzp-CSI-RS-ResourceForInterference), report quantity (reportQuantity), and the like (see FIG. 1).

Each of the resource setting for channel measurement, the CSI-IM resource setting for interference, and the NZP-CSI-RS setting for interference is associated with the CSI resource configuration (CSI-ResourceConfig, CSI-ResourceConfigId). The CSI resource configuration includes a list of CSI-RS resource sets (csi-RS-ResourceSetList, for example, an NZP-CSI-RS resource set or a CSI-IM resource set).

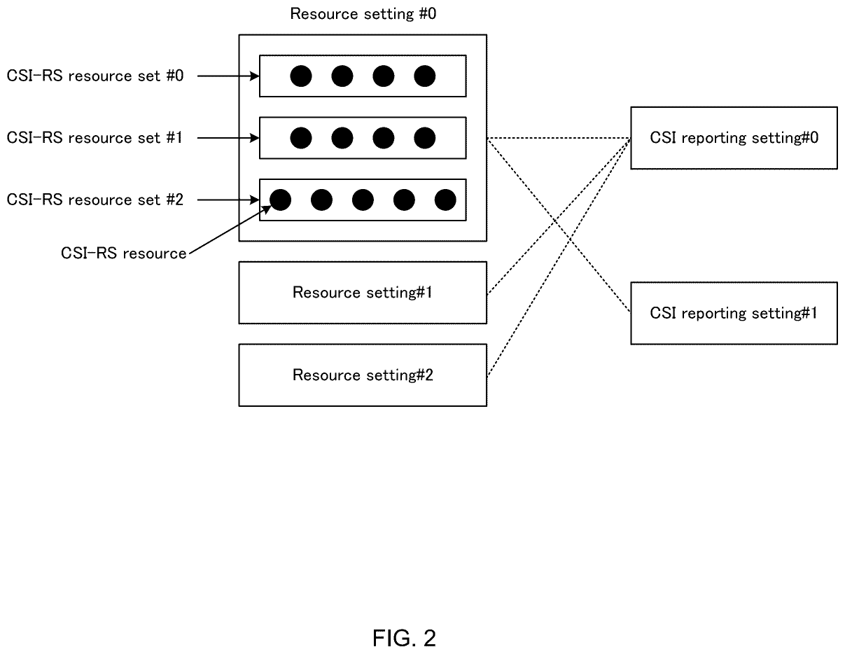

Each resource setting for channel measurement may include one or more CSI-RS resource sets, and each CSI-RS resource set may include one or more CSI-RS resources (see FIG. 2). The CSI-RS resource set corresponding to each resource setting for channel measurement may be separately configured. Here, a case is shown in which resource setting #0 for channel measurement includes CSI-RS resource sets #0 to #2.

A CSI report setting may be associated with one or more resource settings for channel measurement (or a resource setting for channel measurement may be associated with one or more report settings). FIG. 2 shows a case in which resource settings #0 to #2 for channel measurement are associated with CSI report setting #0, and resource setting #0 for channel measurement is associated with CSI report setting #1.

A certain CSI report may be triggered using a certain field included in DCI. The certain CSI report may be an SP-CSI report using a PUSCH (PUSCH-based SP-CSI report), or may be an AP-CSI report using a PUSCH or a PUCCH. For example, a trigger state may be notified/initiated using a CSI request field included in DCI. In this case, a plurality of trigger states may be configured for the UE by a higher layer parameter (for example, CSI-AperiodicTriggerStateList) in advance, and a specific trigger state may be indicated to the UE using DCI.

When the number (L) of CSI trigger states configured by the higher layer parameter is larger than a certain value (for example, 2^{N}_{TS}−1), up to (2^{N}_{TS}−1) trigger states may be mapped to a codepoint of the CSI request field in the DCI, using a MAC CE. The CSI request field in the DCI may indicate a specific trigger state out of up to (2^{N}_{TS}−1) trigger states to the UE.

Each trigger state of the higher layer parameter (for example, CSI-AperiodicTriggerStateList) may include a list of associated report settings. Each report setting may be associated with one, two, or three resource settings. Each resource setting may include one or a plurality of resource sets. Each resource set may include a list of CSI-RS resources.

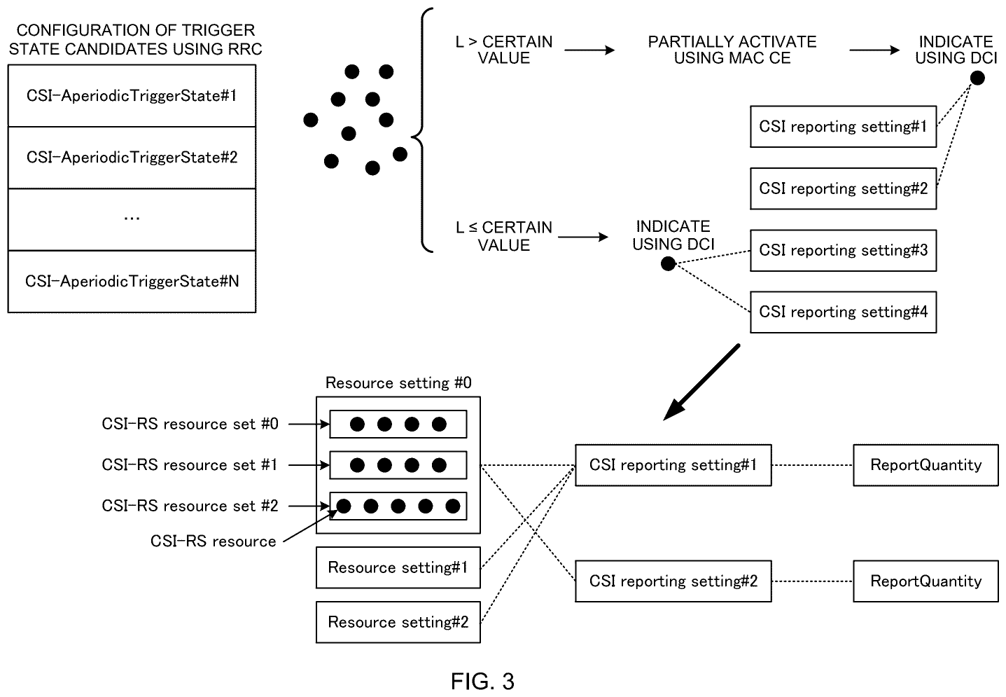

FIG. 3 shows an example of a case in which trigger states #1 to #N are configured by the higher layer parameter (for example, CSI-AperiodicTriggerStateList), and one trigger state is indicated by the CSI request field in the DCI.

Here, when trigger states #1 to #N configured by the higher layer parameter (for example, CSI-AperiodicTriggerStateList) are larger than a certain value, the trigger states up to the certain value are activated by a MAC CE. The activated TCI states are mapped to the codepoint of the CSI request field in the DCI. FIG. 3 shows a case in which one trigger state indicated by the CSI request field is associated with report settings #1 and #2. Each trigger state includes a list of CSI report settings. Here, report setting #1 is associated with resource settings #0 to #2, and report setting #2 is associated with resource setting #0. Report quantity (for example, ReportQuantity) is configured for each report setting.

Alternatively, when trigger states #1 to #N configured by the higher layer parameter (for example, CSI-AperiodicTriggerStateList) are equal to or less than the certain value, the TCI states configured by the higher layer parameter correspond to the codepoint of the CSI request field in the DCI. FIG. 3 shows a case in which one trigger state indicated by the CSI request field is associated with report settings #3 and #4.

### (Application of Artificial Intelligence (AI) Technology to Radio Communication)

Regarding future radio communication technology, utilizing AI technology for control, management, and the like of a network/device has been under study.

For example, regarding future radio communication technology, increasing accuracy of channel estimation (which may be referred to as channel measurement) has been desired for beam management, decoding of a received signal, and the like in communication using beams in particular.

For example, channel estimation may be performed using at least one of a channel state information reference signal (CSI-RS), a synchronization signal (SS), a synchronization signal/broadcast channel (Synchronization Signal/Physical Broadcast Channel (SS/PBCH)) block, a demodulation reference signal (DMRS), a reference signal for measurement (Sounding Reference Signal (SRS)), and the like.

Regarding future radio communication technology, utilizing artificial intelligence (AI) technology such as machine learning (ML) for control, management, and the like of a network/device has been under study.

For example, reducing resources of a reference signal (RS) with maintained channel estimation accuracy using a complement of AI/ML has been under study.

For example, when learning using AI/ML is not performed (has not completed) in the terminal (also referred to as the user terminal, the User Equipment (UE), or the like)/base station, in order to achieve RS reception measurement that enables high channel estimation accuracy or accurate RS reception measurement used for learning, it is considered that the following requirements and the like are required:
transmission and reception of an RS in the wideband (which contributes to enhancement of received quality),
repeated transmission of an RS in order to combine (joint reception) channels/signals received on a receiving side (which contributes to enhancement of received quality),
high time/frequency density of RS resources (which contributes to acquisition of an appropriate correlation of time/frequency).

In the light of these, it is considered that appropriate RS allocation is different between cases in which AI/ML learning is and is not adequately performed. Accordingly, introduction of a methodical framework for dynamically allocating appropriate RS resources is desired.

However, studies on specific details of the framework have not yet been carried out. Unless these are appropriately defined, high-efficiency use of resources cannot be achieved, which may hinder enhancement of communication throughput or communication quality.

For example, when encoded CSI feedback (or CSI report) is supported, how to control triggering of a CSI report having encoded CSI poses a problem.

As an example, how to indicate, to the UE, which to report between existing CSI feedback and AI-encoded CSI feedback poses a problem. Alternatively, how to indicate, to the UE, parameters related to the AI-encoded CSI feedback (for example, encoding parameters/quantization parameters) poses a problem. Alternatively, how operation of the CSI report using the encoded CSI feedback (for example, a certain limitation is configured or the like) is supported poses a problem.

In view of this, the inventors of the present invention studied a control method/UE operation and the like when the encoded CSI feedback is supported, and came up with the idea of the present embodiment.

Note that each embodiment of the present disclosure may be applied when AI/ML/prediction is not used. In this case, even without RRC reconfiguration, a configuration of an RS can be changed with delay/overhead being reduced.

In one embodiment of the present disclosure, the UE/BS performs training of an ML model in a training mode, and implements the ML model in a test mode (also referred to as a testing mode or the like). In the test mode, verification (validation) of accuracy of the ML model (trained ML model) trained in the training mode may be performed.

In the present disclosure, the UE/BS may input channel state information, a reference signal measurement value, and the like to the ML model, and output high-accuracy channel state information/measurement value/beam selection/position, future channel state information/radio link quality, and the like.

Note that, in the present disclosure, AI may be interpreted as an object (also referred to as a target, an object, data, a function, a program, or the like) that has (implements) at least one of the following features:
estimation based on observed or collected information,
selection based on observed or collected information,
prediction based on observed or collected information.

In the present disclosure, the object may be, for example, an apparatus, a device, or the like, such as the terminal and the base station. The object may be a program included in the apparatus.

In the present disclosure, the ML model may be interpreted as an object that has (implements) at least one of the following features:
generating an estimation value through feeding of information,
predicting an estimation value through feeding of information,
finding a feature through feeding of information,
selecting an operation through feeding of information.

In the present disclosure, the ML model may be interpreted as at least one of an AI model, predictive analytics, a predictive analytics model, and the like. The ML model may be derived using at least one of regression analysis (for example, linear regression analysis, multiple regression analysis, or logistic regression analysis), a support vector machine, a random forest, a neural network, deep learning, and the like. In the present disclosure, the model may be interpreted as at least one of an encoder, a decoder, a tool, and the like.

The ML model outputs information of at least one of an estimation value, a prediction value, a selected operation, a class, and the like, based on input information.

In the ML model, supervised learning, unsupervised learning, reinforcement learning, and the like may be included. Supervised learning may be used for learning general rules of mapping input to output. Unsupervised learning may be used for learning features of data. Reinforcement learning may be used for learning an operation for maximizing a target (goal).

Each embodiment to be described later will be described mainly on an assumption of a case in which supervised learning is used for the ML model, but this is not restrictive.

In the present disclosure, implement, use, operate, execute, and the like may be interchangeably interpreted. In the present disclosure, a test, after-training, real use, actual use, and the like may be interchangeably interpreted. A signal may be interchangeably interpreted as a signal/channel.

In the present disclosure, the training mode may be a mode in which the UE/BS transmits/receives a signal for the ML model (that is, an operation mode in a training period). In the present disclosure, the test mode may be a mode in which the UE/BS implements the ML model (for example, implements the trained ML model and predicts output) (that is, an operation mode in a test period).

In the present disclosure, the training mode may mean, with respect to a specific signal to be transmitted in the test mode, a mode in which the specific signal having large overhead (for example, having a large amount of resources) is transmitted.

In the present disclosure, the training mode may mean a mode in which first configuration (for example, first DMRS configuration or first CSI-RS configuration) is referred to. In the present disclosure, the test mode may mean a mode in which second configuration (for example, second DMRS configuration or second CSI-RS configuration), which is different from the first configuration, is referred to. In the first configuration, at least one of time resources, frequency resources, code resources, and ports (antenna ports) related to measurement may be configured in a larger amount than in the second configuration.

Embodiments according to the present disclosure will be described in detail with reference to the drawings as follows. The radio communication methods according to respective embodiments may each be employed individually, or may be employed in combination.

In the following embodiments, the ML model related to communication between the UE and the BS will be described, and related entities are thus the UE and the BS. However, application of each embodiment of the present disclosure is not limited to this. For example, regarding communication between other entities (for example, communication between UEs), the UE and the BS in the following embodiments may be interpreted as a first UE and a second UE. In other words, the UE, the BS, and the like in the present disclosure may each be interpreted as any UE/BS.

In the present disclosure, “A/B” and “at least one of A and B” may be interchangeably interpreted, and “A/B/C” and “at least one of A, B, and C” may be interchangeably interpreted.

In the present disclosure, activate, deactivate, indicate, select, configure, update, determine, and the like may be interchangeably interpreted. In the present disclosure, “support,” “control,” “controllable,” “operate,” and “operable” may be interchangeably interpreted.

In the present disclosure, radio resource control (RRC), an RRC parameter, an RRC message, a higher layer parameter, an information element (IE), and a configuration may be interchangeably interpreted. In the present disclosure, a Medium Access Control control element (MAC Control Element (CE)), an update command, and an activation/deactivation command may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a TRP, spatial relation information (SRI), a spatial relation, an SRS resource indicator (SRI), an SRS resource, a control resource set (CORESET), a Physical Downlink Shared Channel (PDSCH), a codeword, a base station, a reference signal, a certain antenna port (for example, a demodulation reference signal (DMRS) port), a certain antenna port group (for example, a DMRS port group), a certain group (for example, a code division multiplexing (CDM) group, a certain reference signal group, or a CORESET group), a certain resource (for example, a certain reference signal resource), a certain resource set (for example, a certain reference signal resource set), a CORESET pool, a PUCCH group (PUCCH resource group), a spatial relation group, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

In the present disclosure, an index, an ID, an indicator, and a resource ID may be interchangeably interpreted. In the present disclosure, a sequence, a list, a set, a group, a cluster, a subset, and the like may be interchangeably interpreted.

In the present disclosure, a beam report may be interchangeably interpreted as a beam measurement report, a CSI report, a CSI measurement report, a prediction beam report, a prediction CSI report, and the like.

In the present disclosure, a CSI-RS, a non zero power (NZP) CSI-RS, a zero power (ZP) CSI-RS, and a CSI interference measurement (CSI-IM) may be interchangeably interpreted. The CSI-RS may include other reference signals.

In the present disclosure, an RS to be measured/reported may mean an RS to be measured/reported for a CSI report.

In the present disclosure, timing, time point, time, a slot, a sub-slot, a symbol, a subframe, and the like may be interchangeably interpreted.

In the present disclosure, a direction, an axis, a dimension, a domain, polarization, a polarization component, and the like may be interchangeably interpreted.

In the present disclosure, an RS may be a CSI-RS, an SS/PBCH block (SS block (SSB)), or the like, for example. An RS index may be a CSI-RS resource indicator (CRI), an SS/PBCH block resource indicator (SS/PBCH Block Indicator (SSBRI)), or the like.

In the present disclosure, estimation, prediction, and inference may be interchangeably interpreted. In the present disclosure, estimate, predict, and infer may be interchangeably interpreted.

In the present disclosure, an autoencoder, an encoder, a decoder, and the like may be interpreted as at least one of a model, an ML model, a neural network model, an AI model, an AI algorithm, and the like. The autoencoder may be interchangeably interpreted as any autoencoder, such as a stacked autoencoder and a convolutional autoencoder. The encoder/decoder of the present disclosure may employ a model such as a Residual Network (ResNet), DenseNet, and RefineNet.

In the present disclosure, an encoder, encoding, to encode, to modify/change/control using an encoder, and the like may be interchangeably interpreted. In the present disclosure, a decoder, decoding, to decode, to modify/change/control using a decoder, and the like may be interchangeably interpreted.

In the present disclosure, UCI, a CSI report, CSI feedback, feedback information, a feedback bit, and the like may be interchangeably interpreted. In the present disclosure, a bit, a bit string, a bit sequence, a sequence, a value, information, a value obtained from a bit, information obtained from a bit, and the like may be interchangeably interpreted.

In the present disclosure, a layer (regarding an encoder) may be interchangeably interpreted as a layer (an input layer, an intermediate layer, or the like) used in an AI model. The layer of the present disclosure may correspond to at least one of an input layer, an intermediate layer, an output layer, a batch normalization layer, a convolutional layer, a dropout layer, a fully connected layer, and the like.

In the present disclosure, a layer regarding a precoding matrix may be interchangeably interpreted as a Multi Input Multi Output (MIMO) layer, a stream, or the like.

### (Radio Communication Method)

The CSI feedback based on an encoder/decoder (model) will be described with reference to the drawings.

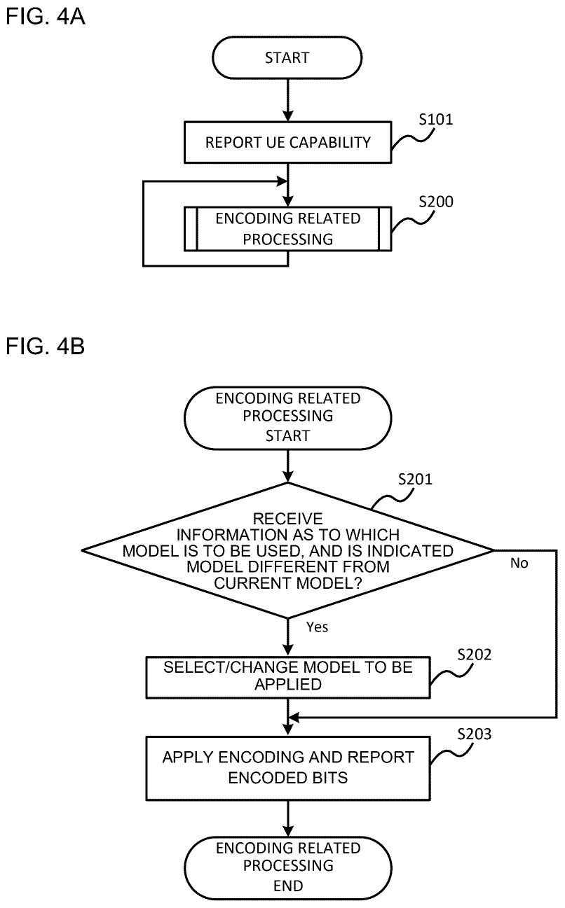

FIGS. 4A and 4B are diagrams to show examples of flowcharts for generating the CSI feedback when one or more trained models are configured in advance.

In Step S101, the UE reports a capability as to whether or not to support inference based on a model for generating the CSI feedback. For example, the UE may report the capability at the time of or after initial access/handover, or may report the capability in response to an inquiry message (for example, an RRC message) about the capability from the base station.

As the capability, the UE may transmit information related to a category/type of a supported model (for example, linear regression, a neural network, an autoencoder, or the like).

Next, in Step S200, the UE performs encoding related processing. FIG. 4B shows an example of a flowchart of the encoding related processing in Step S200.

In the encoding related processing, in Step S201, the UE determines whether or not to receive information as to which model is to be used, and when the UE receives the information, the UE determines whether or not the indicated model is different from the current model (the model applied for generating the CSI feedback).

Note that, when the UE does not receive the information as to which model is to be used, the UE may determine any one of one or more trained models as the current model.

In a case of Step S201—Yes, in Step S202, the UE selects/changes the model applied for generating the CSI feedback to the model indicated by the received information.

After Step S202, or in a case of Step S201—No, in Step S203, the UE applies encoding using the model applied for generating the CSI feedback, and reports encoded bits to the network (for example, the base station).

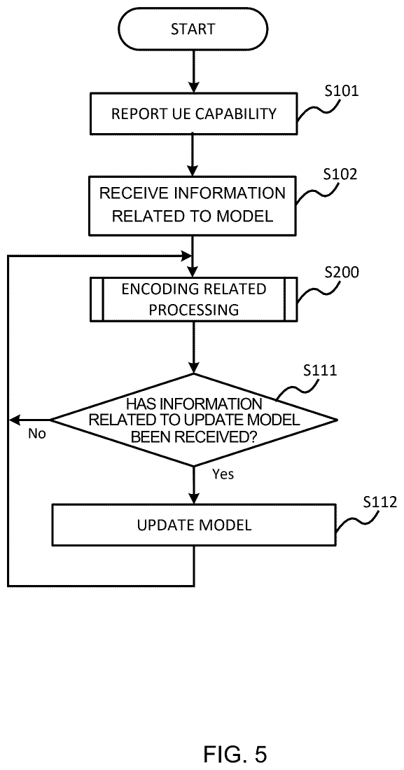

FIG. 5 is a diagram to show an example of a flowchart for generating the CSI feedback when the base station trains a model. Note that the same operations may be employed for the steps denoted by the same reference signs as the above-described steps, and thus detailed description will not be repeated.

In Step S102, the UE receives information related to a model from the base station. To receive the information related to a model may be referred to as to transfer a model. Note that, in the present disclosure, transfer may be interchangeably interpreted as notify, report, configure, communicate, transmit, or the like.

The information related to the model may indicate an appropriate model determined by the network (for example, the base station), and may include, for example, at least one piece of information out of a model ID, a model function, input/output of the model, an application range (for example, an applicable cell), and the like.

Note that, in Step S203 included in Step S200 for the encoding related processing of FIG. 5, not only the encoded bits but information related to model performance may also be reported.

In Step S111, the UE determines whether the UE has received information related to an update model. In a case of Step S111—Yes, in Step S112, the UE updates the model.

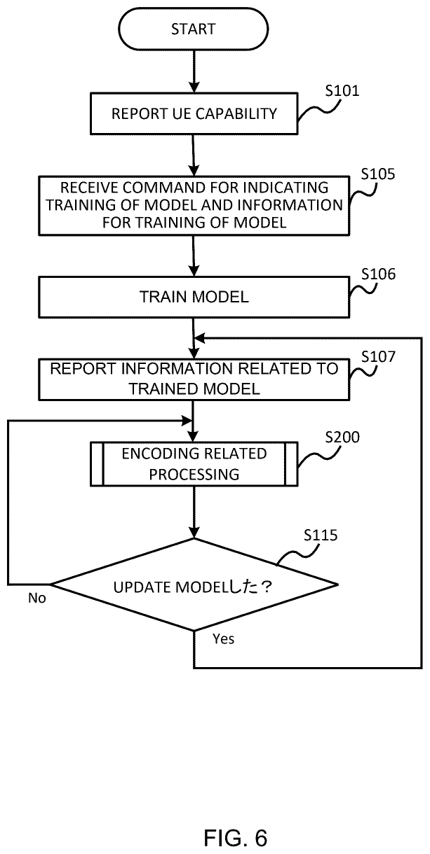

FIG. 6 is a diagram to show an example of a flowchart for generating the CSI feedback when the UE trains a model. Note that the same operations may be employed for the steps denoted by the same reference signs as the above-described steps, and thus detailed description will not be repeated.

In Step S105, the UE receives a command for indicating training of the model and information for training of the model from the base station. In Step S106, the UE transitions to the training mode based on the command for indicating training of the model, and performs training of the model based on the information for training of the model.

In Step S107, the UE reports information related to the trained model. Note that information related to model performance may also be reported.

The UE may update the model at the time of (or after) the encoding related processing of FIG. 6. For example, the UE may perform training/fine-tuning of the used model.

In Step S115, the UE determines whether the UE has updated the model. In a case of Step S115—Yes, in Step S107, the UE reports information related to the trained model (which may include information related to training/fine-tuning).

Note that transmission/reception of the information shown in each flowchart may be performed using physical layer signaling (for example, DCI, UCI), higher layer signaling (for example, RRC signaling, a MAC CE), or a specific signal/channel, or a combination of these.

Note that processing (decoding related processing) on the base station side corresponding to each flowchart can be understood by a person skilled in the art as opposite processing of the encoding related processing. The base station can estimate CSI information before being encoded by inputting encoded bits transmitted from the UE to the model of the decoder corresponding to the encoder applied by the UE.

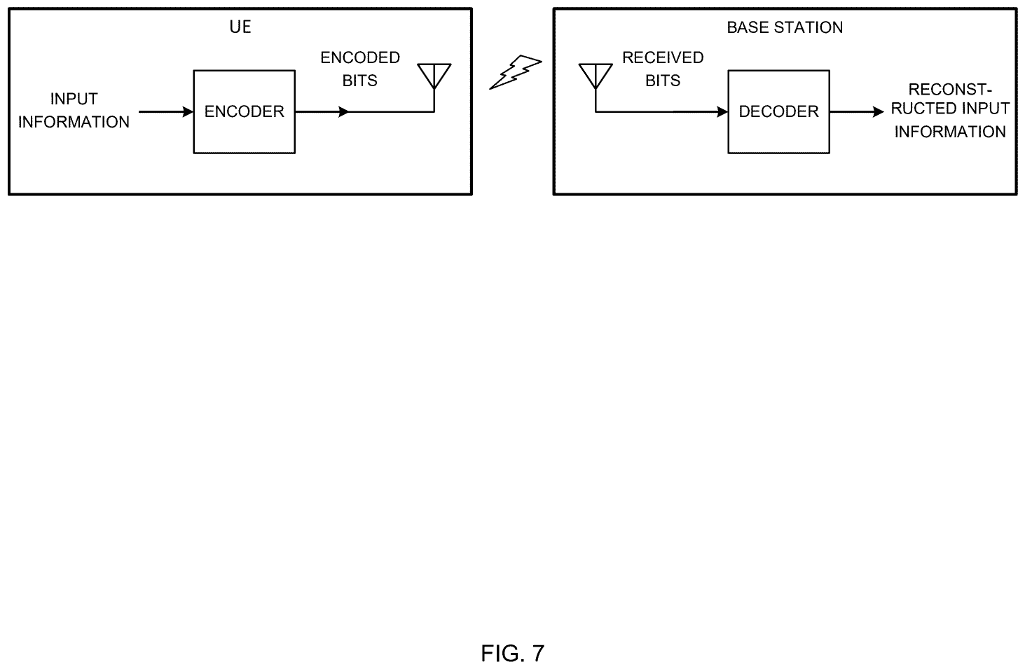

FIG. 7 is a diagram to show an example of the CSI feedback using the encoder/decoder in the present disclosure. The UE transmits, from an antenna, information (CSI feedback) including encoded bits that are output after inputting input information to the encoder. The base station obtains reconstructed input information that is output after inputting the received bits of the CSI feedback to a corresponding decoder.

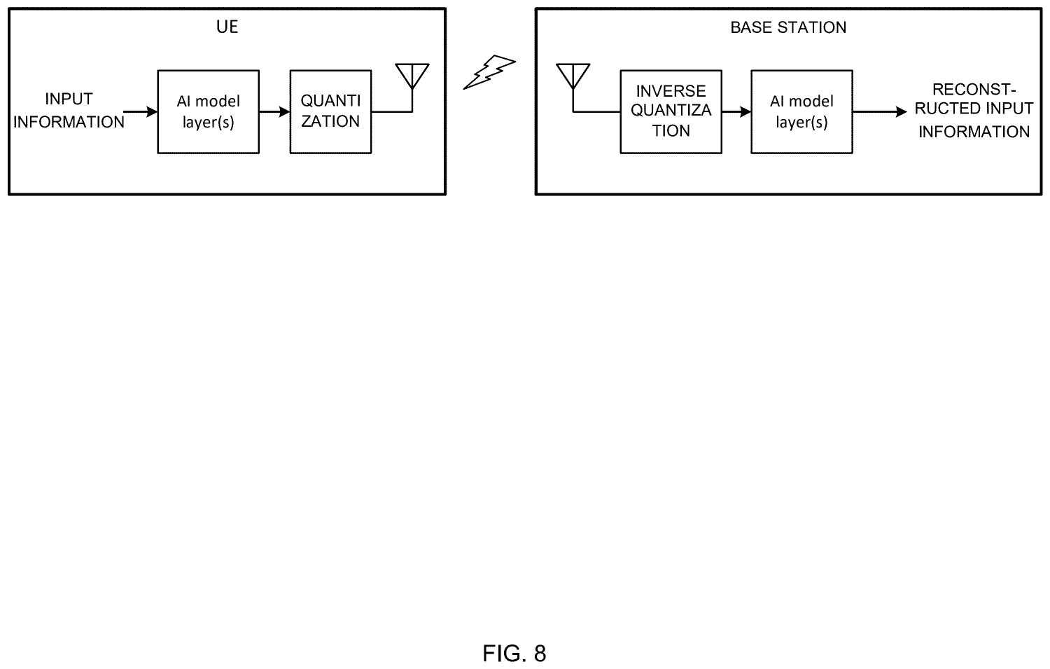

FIG. 8 is a diagram to show an example of the CSI feedback using the encoder/decoder in which quantization in the present disclosure is introduced. The UE performs specific quantization in encoding or on encoded values/bits, and transmits information (CSI feedback) including quantized bits from an antenna. Note that, in the present example and the following drawings, “AI model layer(s)” may mean an encoder/decoder implemented using one or more layers.

The base station applies corresponding inverse quantization to the received bits of the CSI feedback, and obtains reconstructed input information that is output after inputting the inversely quantized values/bits to a corresponding decoder.

### First Embodiment

A first embodiment will describe CSI to be fed back/reported by the UE.

The network (or the base station) may indicate/configure, for the UE, information related to the CSI to be fed back by the UE. Feedback may be interpreted as report. For example, the base station may indicate, to the UE, which is to be performed between encoded CSI feedback (for example, encoded CSI feedback) and conventional CSI feedback (for example, conventional CSI feedback). The conventional CSI feedback may be CSI feedback supported in existing systems (for example, Rel. 16 or previous versions).

As a method of indicating the CSI to be fed back to the UE (or a method for the UE to determine the CSI to be fed back), at least one of the following option 1-1 to option 1-7 may be applied/supported. Note that which is to be used among option 1-1 to option 1-7 may be defined in a specification, may be indicated from the base station to the UE, or may be determined based on a certain condition (for example, UE capability information, a type/classification of CSI, or the like).

### [Option 1-1]

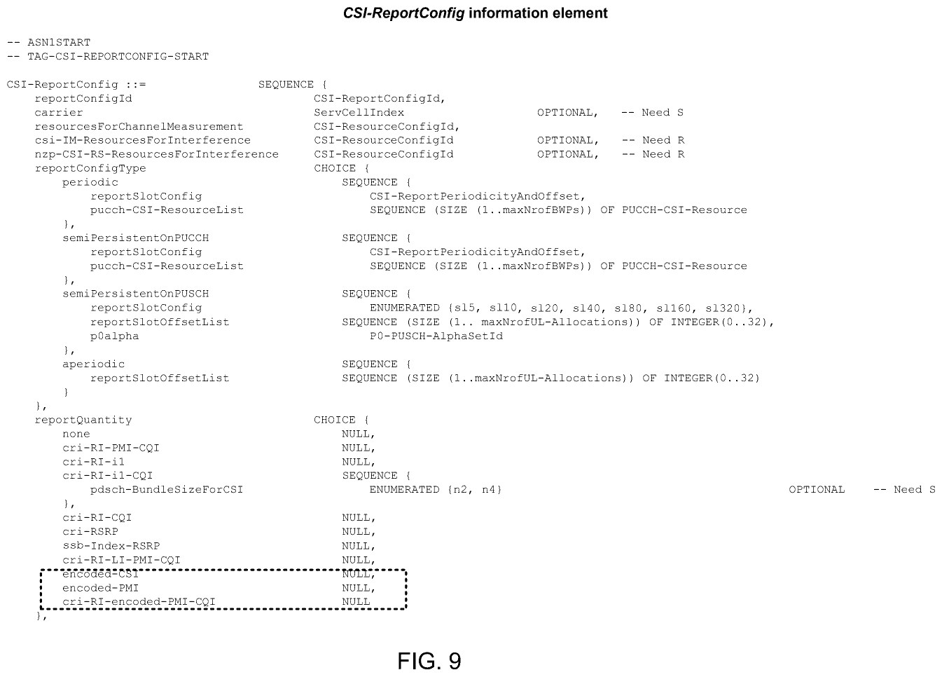

Which is to be reported between first CSI (for example, the encoded CSI feedback) and second CSI (for example, the conventional CSI feedback) may be notified to the UE, using a certain higher layer parameter. The certain higher layer parameter may be a specific parameter (here, report quantity information (for example, reportQuantity)) included in the CSI report configuration (for example, CSI-ReportConfig) (see FIG. 9).

In this case, a parameter value (for example, encoded CSI/PMI) indicating new report quantity may be configured for the report quantity included in the CSI report configuration.

For example, the new report quantity (for example, encoded-CSI) may indicate that an auto-encoded channel matrix (for example, auto-encoded Channel matrix) is to be reported. The new report quantity (for example, encoded-PMI) may indicate that an auto-encoded PMI matrix (for example, auto-encoded PMI matrix) is to be reported. Note that, in the present disclosure, an auto-encoded PMI may be interpreted as an auto-encoded precoding matrix (for example, auto-encoded Precoding Matrix) or an encoded precoding matrix.

Any combination of the new report quantity (for example, encoded-CSI/encoded-PMI) and the conventional report quantity may be defined/configured/notified. For example, a combination of at least one of the CSI, the RI, the LI, and the COI and at least one of the encoded-CSI and the encoded-PMI may be supported.

As an example, at least one combination of cri-RI-encoded-PMI-CQI, cri-RI-encoded-PMI, cri-RI-LI-encoded-PMI-CQI, cri-RI-encoded-CSI-CQI, cri-RI-encoded-CSI, and cri-RI-LI-encoded-CSI-CQI may be supported.

When the CSI report is configured using the new report quantity, the encoded CSI may be reported/fed back. Otherwise, the conventional CSI may be reported/fed back.

In this manner, by indicating the report of the encoded CSI/PMI to the UE with the use of the report quantity information (for example, reportQuantity), the UE can appropriately determine the CSI to be reported even when the encoded CSI (or the encoded PMI) is supported.

### [Option 1-2]

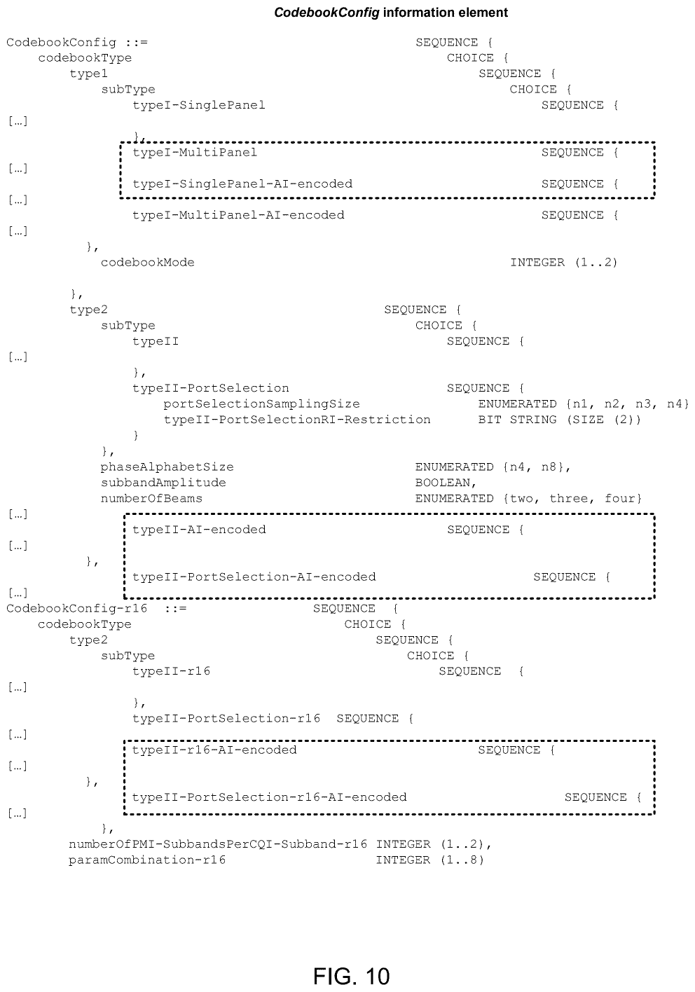

Which is to be reported between first CSI (for example, the encoded CSI feedback) and second CSI (for example, the conventional CSI feedback) may be notified to the UE, using a certain higher layer parameter. The certain higher layer parameter may be a specific parameter (here, a codebook configuration (for example, codebookConfig)) included in the CSI report configuration (for example, CSI-ReportConfig) (see FIG. 10).

In this case, a new parameter value may be configured for the codebook configuration included in the CSI report configuration. Regarding the new parameter value (for example, a parameter corresponding to encoding), a parameter for encoding may be newly added to the conventional parameter value.

For example, at least one new codebook type out of type-I-AI-encoded, type-I-single-panel-AI-encoded, type-I-multi-panel-AI-encoded, type-II-AI-encoded, type-II-port-selection-AI-encoded, type-II-r16-AI-encoded, and type-II-port-selection-r16-AI-encoded may be configured/supported.

When the CSI report is configured using the new codebook type, the AI-encoded CSI may be reported (or the AI-encoded CSI feedback may be performed).

### [Option 1-3]

Which is to be reported between first CSI (for example, the encoded CSI feedback) and second CSI (for example, the conventional CSI feedback) may be notified to the UE, using a certain higher layer parameter. The certain higher layer parameter may be the CSI report configuration (for example, CSI-ReportConfig).

In other words, option 1-1/1-2 corresponds to a case in which information related to the encoded CSI report is included in a certain parameter (for example, a parameter for another purpose) included in the CSI report configuration. Option 1-3 corresponds to a case in which a new parameter related to the encoded CSI report is defined/configured for the CSI report configuration.

For the CSI report configured using certain report quantity (for example, certain report quantity), the UE may determine whether to report the conventional PMI or report the encoded CSI/PMI, based on a configuration of a new parameter in the CSI report configuration (for example, CSI-ReportConfig). The conventional PMI may be type-I/type-II/type-II-port selection/enhanced type-II/enhanced type-II-port selection, for example.

The certain report quantity may be defined by a specification, or may be configured by RRC. For example, the report quantity including PMI information may be at least one of cri-RI-PMI-CQI, cri-RI-i1, cri-RI-i1-CQI, and cri-RI-L1-PMI-CQI.

A new parameter (for example, EncodedCsi) may be configured for the CSI report configuration (for example, CSI-ReportConfig). The new parameter may be a parameter (for example, EncodedCsi) indicating a report of the encoded CSI/PMI (or presence or absence of the report). For example, EncodedCsi may be used for indication of any one of or at least one of information (for example, No encoding) indicating no encoding, information (for example, encoded channel matrix) indicating an encoded channel matrix, and information (encoded PMI) indicating an encoded PMI.

When a CSI report (for example, a certain CSI report ID) is activated, a configuration of encoding/no encoding (for example, EncodeCsi) corresponding to the CSI report may be applied.

When the new parameter (for example, EncodedCsi) is not configured (for example, when EncodeCsi is not included in CSI-ReportConfig), a certain rule/default configuration may be applied. For example, when the new parameter is not included, no encoding may be applied by default (for example, the conventional PMI report is reported).

When a certain condition is satisfied, the UE need not assume that the new parameter (for example, EncodedCsi) is configured (or may assume that EncodedCsi is not configured) for the CSI report. Alternatively, when the certain condition is satisfied, the UE need not assume that the new parameter (for example, EncodedCsi) indicates the encoded CSI feedback (or may assume that EncodedCsi does not indicate the encoded CSI feedback) for the CSI report.

The certain condition may be a codebook type corresponding to the CSI report. For example, when the codebook type is a specific codebook type, this may correspond to a case in which a specific condition is satisfied. The specific codebook type may be at least one of subband-granularity-type-I codebook, wideband-granularity-type-I codebook, type-II codebook, type-II codebook port selection, enhanced type-II codebook, and enhanced type-II codebook port selection.

### [Option 1-4]

Which is to be reported between first CSI (for example, the encoded CSI feedback) and second CSI (for example, the conventional CSI feedback) may be notified to the UE, using a certain higher layer parameter. The certain higher layer parameter may be a parameter related to the trigger state of the CSI.

The parameter related to the trigger state of the CSI may be at least one of a parameter (for example, CSI-AperiodicTriggerState or CSI-AssociatedReportConfigInfo) configured/used for a configuration of the aperiodic CSI report and a parameter (for example, CSI-SemiPersistentOnPUSCH-TriggerState) configured/used for the semi-persistent CSI report.

A new parameter value may be configured for the parameter (for example, CSI-AperiodicTriggerState/CSI-AssociatedReportConfigInfo/CSI-SemiPersistentOnPUSCH-TriggerState) related to the trigger state of the CSI. The new parameter may be a parameter (for example, EncodedCsi) indicating a report of the encoded CSI/PMI (or presence or absence of the report). For example, EncodedCsi may be used for indication of any one of or at least one of information (for example, No encoding) indicating no encoding, information (for example, encoded channel matrix) indicating an encoded channel matrix, and information (encoded PMI) indicating an encoded PMI.

For the CSI report configured using certain report quantity (for example, certain report quantity), the UE may determine whether to report the conventional PMI or report the encoded CSI/PMI, based on a configuration of a corresponding new parameter for the trigger state. The conventional PMI may be type-I/type-II/type-II-port selection/enhanced type-II/enhanced type-II-port selection, for example.

The certain report quantity may be defined by a specification, or may be configured by RRC. For example, the report quantity including PMI information may be at least one of cri-RI-PMI-CQI, cri-RI-i1, cri-RI-i1-CQI, and cri-RI-L1-PMI-CQI.

When the new parameter (for example, EncodedCsi) is configured for the higher layer parameter (for example, CSI-AperiodicTriggerState/CSI-SemiPersistentOnPUSCH-TriggerState) related to the trigger state of the CSI, the UE may determine the CSI to be reported, based on the new parameter corresponding to the trigger state indicated/triggered from the base station.

For example, when a certain trigger state is triggered, and the encoded CSI feedback is configured by the new parameter corresponding to the trigger state, the encoded CSI may be reported. In this case, the encoded CSI may be selected for all of the CSI reports associated with the trigger state. Otherwise, the conventional CSI may be reported.

When the encoded CSI feedback is configured by the new parameter, the encoded CSI may be reported for the CSI report associated with a CSI report having a specific codebook type configuration.

Alternatively, the UE may determine/assume presence or absence of the configuration of the encoded CSI feedback for the trigger state, based on the codebook type configured for the CSI report associated with the trigger state. For example, when the specific codebook type configuration is configured for any one of or all of the CSI reports associated with the trigger state, the UE does not assume that the encoded CSI feedback is configured for the trigger state (or assumes that the encoded CSI feedback is not configured for the trigger state).

The specific codebook type configuration may be a configuration of at least one of subband-granularity-type-I codebook, wideband-granularity-type-I codebook, type-II codebook, type-II codebook port selection, enhanced type-II codebook, and enhanced type-II codebook port selection.

In this manner, by associating the information related to the encoded CSI feedback with the trigger state indicated by DCI/activation MAC CE, presence or absence of the encoded CSI feedback can be dynamically indicated.

### [Option 1-5]

Which is to be reported between first CSI (for example, the encoded CSI feedback) and second CSI (for example, the conventional CSI feedback) may be notified to the UE using DCI used for triggering/MAC CE used for activation. The DCI used for triggering (for example, triggering DCI) may be used for triggering of the aperiodic CSI report, and the MAC CE used for activation (activation MAC CE) may be used for activation of the semi-persistent CSI report.

An explicit DCI/MAC CE field may indicate the conventional CSI feedback (for example, no encoding) or the encoded CSI feedback (for example, the encoded channel matrix, or the encoded PMI).

When the CSI report is triggered by the DCI, at least one of the following DCI configuration A and configuration B may be applied/supported.

### <<DCI Configuration A>>

A new DCI field for indicating encoding/no encoding may be defined/configured for the DCI.

### <<DCI Configuration B>>

In order to indicate encoding/no encoding, an existing certain DCI field included in the DCI may be reused. The certain DCI field may be an HPN, a TCI/SRI, or the like (for example, when the DCI does not schedule the PDSCH/PUSCH). For example, a plurality of existing DCI fields may be combined to indicate availability of an encoded/non-encoded CSI indication. For example, in a case of frequency domain resource allocation (FDRA) field=all 0, time domain resource allocation (TDRA) field=all 0, MCS field=all 0, RV field=all 0, and NDI field=all 0, the encoded or non-encoded CSI indication may be performed.

When the CSI report is activated by the MAC CE, at least one of the following MAC CE configuration A and configuration B may be applied/supported.

### <<MAC CE Configuration A>>

A new octet for indicating encoding/no encoding may be defined/configured for the MAC CE.

### <<MAC CE Configuration B>>

In order to indicate encoding/no encoding, an existing octet included in the MAC CE may be reused. For example, reserved bits (for example, Reserved bits) included in the existing octet may be used to indicate whether or not the MAC CE is interpreted as the encoded/non-encoded CSI report indication.

When the encoded CSI feedback is indicated by the triggering DCI, the encoded CSI may be reported for an associated CSI report having a specific codebook type configuration.

Alternatively, the UE may determine/assume presence or absence of the indication of the encoded CSI feedback using the DCI/MAC CE, based on the codebook type configured for the CSI report associated with the trigger state. For example, when the specific codebook type configuration is configured for any one of or all of the CSI reports associated with the trigger state, the UE does not assume that the encoded CSI feedback is indicated by the triggering DCI or the activation MAC CE (or assumes that the encoded CSI feedback is not indicated by the triggering DCI or the activation MAC CE).

The specific codebook type configuration may be a configuration of at least one of subband-granularity-type-I codebook, wideband-granularity-type-I codebook, type-II codebook, type-II codebook port selection, enhanced type-II codebook, and enhanced type-II codebook port selection.

### [Option 1-6]

Which is to be reported between first CSI (for example, the encoded CSI feedback) and second CSI (for example, the conventional CSI feedback) may be notified to the UE using DCI/MAC CE. In option 1-6, the DCI is not limited to the DCI used for triggering of the CSI, and the MAC CE is not limited to the MAC CE used for activation of the CSI.

### <<DCI>>

As a format of the DCI used for indication of the encoded CSI feedback/non-encoded CSI feedback, an existing DCI format (for example, a DL/UL grant) having an existing RNTI may be applied. In this case, DCI configuration A/configuration B of option 1-5 may be applied.

Alternatively, as a format of the DCI used for indication of the encoded CSI feedback/non-encoded CSI feedback, an existing DCI format having a new RNTI may be applied.

Alternatively, as a format of the DCI used for indication of the encoded CSI feedback/non-encoded CSI feedback, a new DCI format may be defined/supported.

### <<MAC CE>>

As the MAC CE used for indication of the encoded CSI feedback/non-encoded CSI feedback, an existing MAC CE may be applied. In this case, MAC CE configuration A/configuration B of option 1-5 may be applied.

Alternatively, as the MAC CE used for indication of the encoded CSI feedback/non-encoded CSI feedback, a new MAC CE may be defined/supported.

The encoding/no encoding indication may be applied to all of the activated/triggered CSI reports, or may be applied to a specific CSI report. The specific CSI report may be configured for the UE by RRC, or may be indicated by DCI/MAC CE (for example, DCI/MAC CE used for triggering/activation).

Alternatively, the UE may determine presence or absence of the encoding/no encoding indication, based on the codebook type corresponding to the CSI report. For example, the encoding/no encoding indication need not be applied to the CSI report having a specific codebook type configuration.

The specific codebook type configuration may be a configuration of at least one of subband-granularity-type-I codebook, wideband-granularity-type-I codebook, type-II codebook, type-II codebook port selection, enhanced type-II codebook, and enhanced type-II codebook port selection.

When the UE receives the DCI/MAC CE indicating the encoded CSI or the non-encoded CSI, the indicated encoded CSI/non-encoded CSI report may be applied from slot #N+k. Slot #N may be a DCI slot for indication or a slot in which a PUCCH report of a HARQ-ACK for the PDSCH on which the MAC CE is transmitted is performed, and k may be an integer value defined in a specification.

### [Option 1-7]

Which is to be reported between first CSI (for example, the encoded CSI feedback) and second CSI (for example, the conventional CSI feedback) may be implicitly notified to the UE, using presence of parameters related to the encoded CSI feedback (or presence or absence of a configuration).

When the parameters related to the encoded CSI feedback (for example, the CSI feedback related parameters) are configured for the CSI report (or a related trigger state), the encoded CSI feedback may be performed. Otherwise, the conventional CSI feedback may be performed. The CSI feedback related parameter may be one of the parameters to be described in a second embodiment.

### Variations

Option 1-1 to option 1-7 have described a case in which the CSI to be fed back is indicated from the base station to the UE, but the present embodiment is not limited to this. The UE may determine the CSI to be reported. For example, the UE may autonomously select which is to be reported between first CSI (for example, the encoded CSI feedback) and second CSI (for example, the conventional CSI feedback).

When the UE reports/feeds back the selected CSI, the UE may transmit information related to the selected CSI (for example, whether the CSI to be reported is the first CSI or the second CSI) to the base station. The information related to the CSI selected by the UE may be transmitted to the base station by being included in the CSI report, or may be transmitted to the base station separately from the CSI report.

Which is to be applied between the method of indicating the CSI to be fed back from the base station to the UE (at least one of option 1-1 to option 1-7) and the method in which the UE autonomously selects the CSI to be fed back may be defined in a specification, may be configured for the UE by higher layer signaling or the like, or may be determined based on UE capability information.

### Second Embodiment

A second embodiment will describe a method of indicating parameters (for example, encoded CSI feedback related parameters) to be applied to the encoded CSI feedback/report and at least one of the quantization parameters.

The encoded CSI feedback related parameters may include CSI encoder parameters (for example, CSI encoder parameters) and at least one of the quantization parameters (for example, the quantization parameters), for example. The CSI encoder parameters may include at least one of auto-encoder selection (for example, auto-encoder selection) and a compression rate (for example, a compression rate). The quantization parameters (for example, quantization parameters) may include at least one of a quantization function (for example, a quantization function) and a quantization level (for example, a quantization level).

At least one of the encoded CSI feedback related parameters and the quantization parameters may be transmitted using at least one of the following option 2-1 to option 2-3.

### [Option 2-1]

At least one of the encoded CSI feedback related parameters and the quantization parameters may be configured/notified to the UE, using a higher layer parameter related to the CSI report configuration. The higher layer parameter related to the CSI report configuration may be at least one of CSI-ReportConfig and CSI-AssociatedReportConfigInfo, for example.

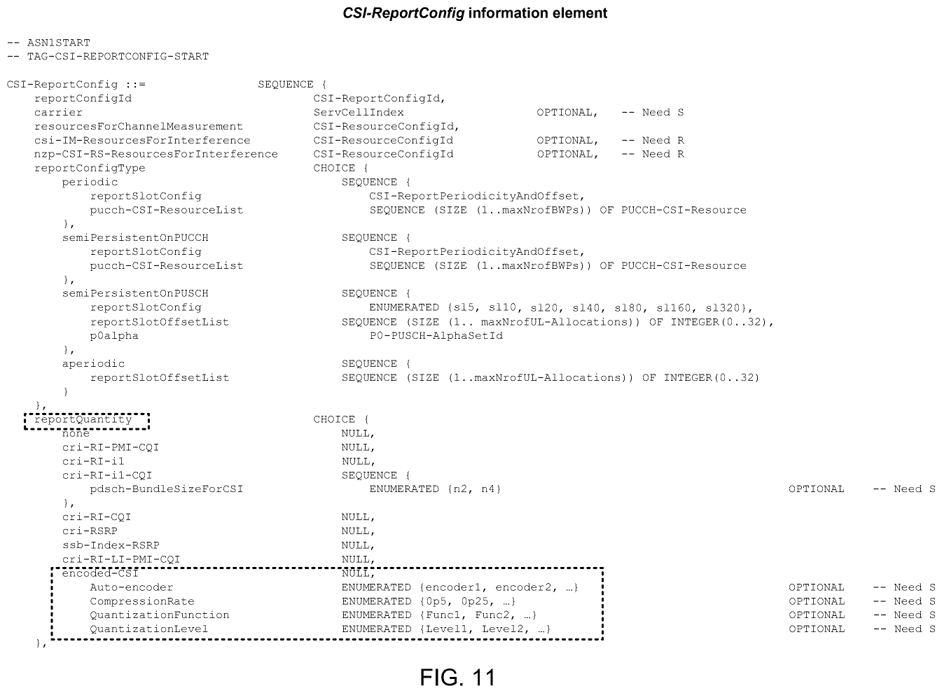

When a new value (for example, report quantity) is introduced/configured for a certain parameter (for example, the report quantity (reportQuantity)) of the CSI report configuration (for example, option 1-1 in the first embodiment), the encoded CSI feedback related parameters may be configured for a report quantity type configuration (for example, a report quantity type configuration) (see FIG. 11).

Alternatively, when a new codebook type is introduced/configured for a certain parameter (for example, the codebook configuration (codebookConfig)) of the CSI report configuration (option 1-2 in the first embodiment), the encoded CSI feedback related parameters may be configured for a configuration of the codebook type.

Alternatively, the encoded CSI feedback related parameters may be indicated using another information element (for example, IE) in a CSI report setting CSI report configuration (for example, CSI reporting setting CSI-ReportConfig) or in CSI associated report configuration information (for example, CSI-AssociatedReportConfigInfo).

### [Option 2-2]

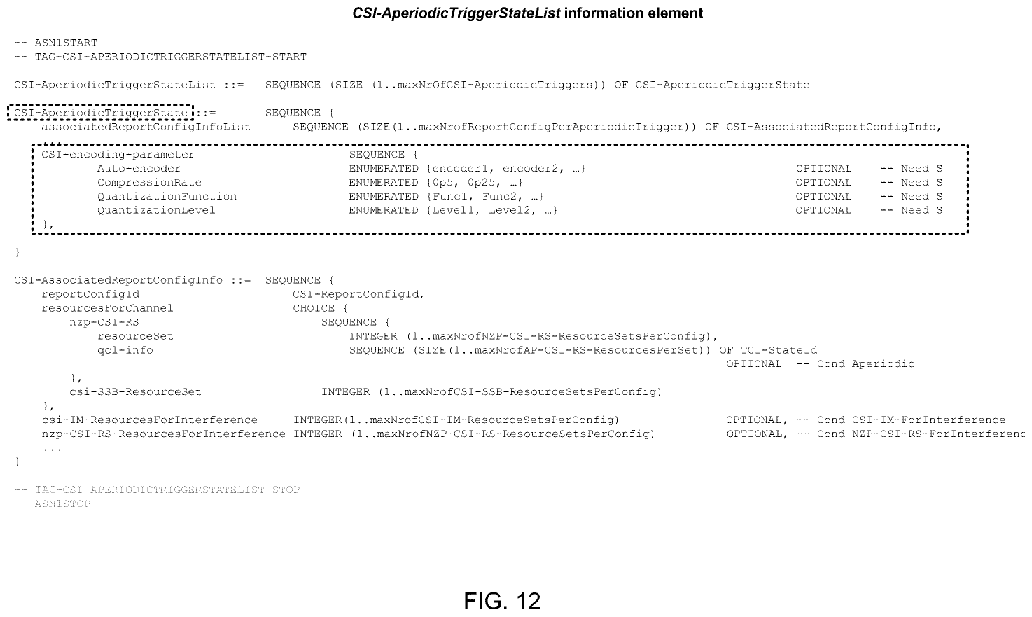

The encoded CSI feedback related parameters may be implicitly indicated by a parameter (for example, an RRC configuration parameter) included in certain higher layer parameters related to the trigger state of the CSI and triggering DCI/activation MAC CE. The certain higher layer parameters may be CSI-SemiPersistentOnPUSCH-TriggerState/CSI-SemiPersistentOnPUSCH-TriggerStateList, or CSI-AperiodicTriggerState/CSI-AperiodicTriggerStateList (see FIG. 12).

For example, the encoded CSI feedback related parameters may be configured for each trigger state (or per trigger state). Each trigger state may be a trigger state included in the certain higher layer parameters. When the DCI triggers the aperiodic CSI report or the MAC CE activates the semi-persistent CSI report, the encoded CSI feedback related parameters configured for the trigger state may be applied to all of the CSI reports associated with the trigger state.

### [Option 2-3]

The encoded CSI feedback related parameters may be explicitly indicated by the DCI used for triggering/MAC CE used for activation.

For example, a plurality of encoded CSI feedback related parameters (or an encoded CSI feedback related parameter set) may be configured for the UE by higher layer signaling in advance, and a specific encoded CSI feedback related parameter may be indicated out of the plurality of encoded CSI feedback related parameters by a certain field included in the DCI/MAC CE.

The plurality of encoded CSI feedback related parameters (or the encoded CSI feedback related parameter set) may be configured for each certain parameter. “For each certain parameter” may be “for each CSI measurement configuration (for example, CSI-MeasConfig)”, “for each CSI report configuration (for example, CSI-ReportConfig)”, or “for each trigger state (for example, CSI-SemiPersistentOnPUSCH-TriggerState/CSI-SemiPersistentOnPUSCH-TriggerStateList, or CSI-AperiodicTriggerState/CSI-AperiodicTriggerStateList)”.

The second embodiment may be applied to other parameters necessary for the encoded CSI feedback. For example, such other parameters may be parameters indicating information as to which encoder is used, a quantization process of the encoded CSI feedback, a compression rate of the encoded bits, or the like, for example.

To which parameter the second embodiment is applied may be defined in a specification, may be configured by a higher layer parameter, may be determined based on a UE capability reported by the UE, or may be determined based on or a combination of these (for example, a configuration by a UE capability and a higher layer parameter).

### Third Embodiment

A third embodiment will describe a time domain behavior property (for example, a time domain behavior property) to be applied to the encoded CSI feedback/report (for example, the auto-encoded CSI report) and an uplink channel.

### [Time Domain Behavior Property]

The encoded CSI may be fed back in the CSI report having a certain time domain behavior property (for example, time domain behavior property). The time domain behavior property may be a temporal type of the CSI report, and may be at least one of the periodic CSI/semi-persistent CSI/aperiodic CSI, for example.

The encoded CSI feedback may be supported for only any one of the periodic CSI report/semi-persistent CSI report/aperiodic CSI report.

Alternatively, the encoded CSI feedback may be supported for the periodic CSI report/semi-persistent CSI report/aperiodic CSI report.

Alternatively, the encoded CSI feedback may be supported for the periodic CSI report/semi-persistent CSI report.

Alternatively, the encoded CSI feedback may be supported for the semi-persistent CSI report/aperiodic CSI report.

Note that the time domain behavior property of the CSI report supporting the encoded CSI feedback may be defined in a specification, may be configured from the base station to the UE using higher layer signaling, or may be determined based on a UE capability.

### [Uplink Channel]

The encoded CSI may be fed back in certain uplink channel(s) (for example, one or more uplink channels, or only a specific uplink channel).

The encoded CSI feedback may be supported for only a report using an uplink control channel (for example, the PUCCH).

Alternatively, the encoded CSI feedback may be supported for only a report using a specific uplink control channel format (for example, a PUCCH format). The specific PUCCH format may be one or a plurality of PUCCH formats. For example, the specific PUCCH format may be PUCCH format 3/4.

Alternatively, the encoded CSI feedback may be supported for only a report using an uplink shared channel (for example, the PUSCH).

Alternatively, the encoded CSI feedback may be supported for only the report using the PUSCH, regardless of whether or not UL data (for example, a UL-SCH) is multiplexed/mapped to the uplink shared channel (for example, the PUSCH).

Alternatively, the encoded CSI feedback may be supported for a report using the PUCCH (for example, a certain PUCCH format) and the PUSCH (for example, with/without the UL-SCH).

Note that the uplink channel used for the encoded CSI feedback may be defined in a specification, may be configured from the base station to the UE using higher layer signaling, or may be determined based on a UE capability.

### [Time Domain Behavior Property+Uplink Channel]

The encoded CSI may be fed back in the CSI report having a certain time domain behavior property (for example, time domain behavior property) and to which a certain uplink channel is applied.

For example, the encoded CSI feedback may be supported in only the periodic CSI report using a specific PUCCH format (for example, PUCCH format 3/4).

For example, the encoded CSI feedback may be supported in only the periodic CSI report/semi-persistent CSI report using a specific PUCCH format (for example, PUCCH format 3/4) and the aperiodic CSI report using the PUSCH without the UL-SCH.

A limitation of the encoded CSI report may be separately/differently applied based on at least one of a target to be encoded (for example, encoded-CSI/encoded-PMI), a type of an encoder (for example, a type of encoder), and length of the encoded bits (for example, length of encoded bits).

For example, encoded channel matrix feedback (for example, encoded channel matrix feedback) may be performed using only the PUSCH. Encoded PMI feedback (for example, encoded PMI feedback) may be performed using only a specific PUCCH format (for example, PUDCH format 3/4) and the PUSCH.

Alternatively, the encoded CSI/encoded PMI by encoder #1 may be supported in the periodic/semi-persistent/aperiodic CSI report. On the other hand, the encoded CSI/encoded PMI by encoder #1 may be supported in only a specific time domain behavior property (for example, the aperiodic CSI report).

### (UE Capability Information)

In the first embodiment to the third embodiment, the following UE capabilities may be configured. Note that the following UE capabilities may each be interpreted as a parameter (for example, a higher layer parameter) configured from the network (for example, the base station) to the UE.

UE capability information as to whether or not to support the encoded CSI feedback may be defined.

UE capability information as to whether or not to support new report quantity (for example, the report quantity) for the encoded CSI feedback may be defined.

UE capability information as to whether or not to support a new codebook type (for example, the codebook type) for the encoded CSI feedback may be defined.

UE capability information as to whether or not to support the DCI/MAC CE used for indication of CSI encoding parameters (for example, the encoded CSI feedback related parameters) may be defined.

UE capability information as to whether or not to support the encoded CSI report using the PUCCH (for example, the specific PUCCH format) may be defined.

UE capability information as to whether or not to support the encoded CSI report using the PUSCH (for example, with/without the UL-SCH) may be defined.

UE capability information as to whether or not to support the encoded CSI report using the periodic CSI report/semi-persistent CSI report/aperiodic CSI report may be defined.

The first embodiment to the third embodiment may be applied to the UE that supports/reports at least one of the UE capabilities described above. Alternatively, the first embodiment to the third embodiment may be applied to the UE configured from the network.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

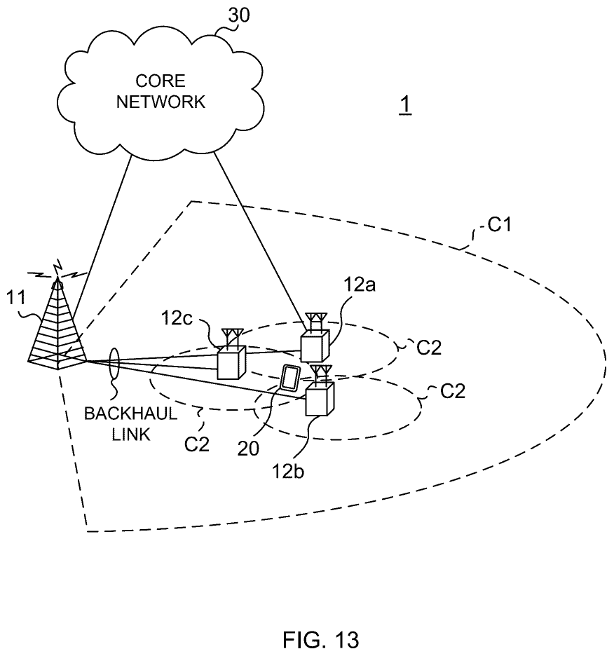

FIG. 13 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHZ), and FR2 may be a frequency band which is higher than 24 GHZ (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, and 5G.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-S-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a reference signal for measurement (Sounding Reference Signal (SRS)), a demodulation reference signal (DMRS), and so on may be communicated as an uplink reference signal (UL-RS). Note that DMRS may be referred to as a “user terminal specific reference signal (UE-specific Reference Signal).”

### (Base Station)

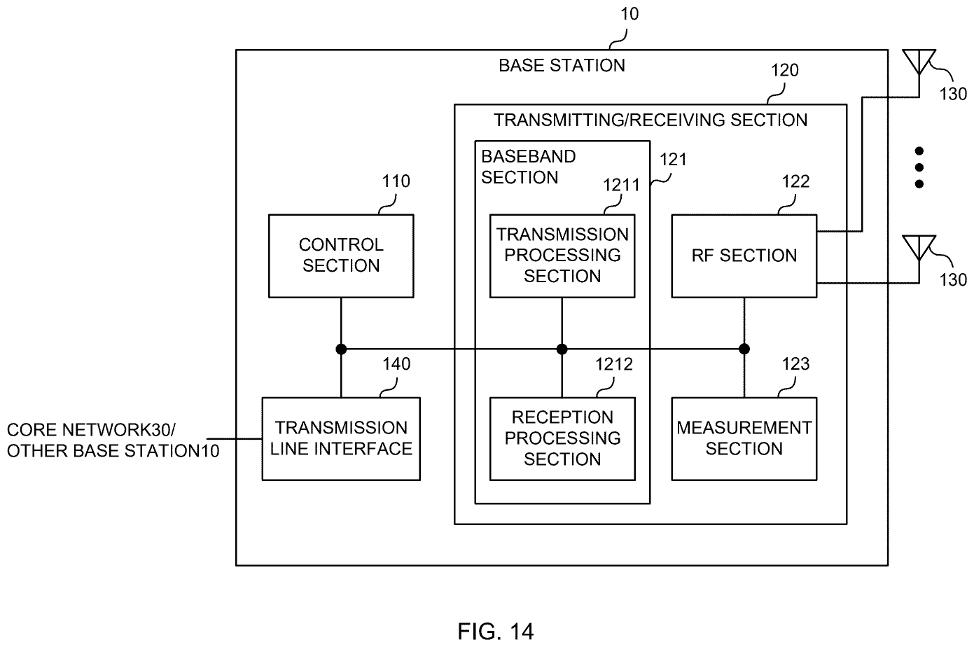

FIG. 14 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

Note that the transmitting/receiving section 120 may transmit, to a terminal, information related to a channel state information (CSI) report indicating at least one of a report of encoded first CSI and a report of second CSI different from the first CSI. The control section 110 may determine CSI reported from the terminal based on the information related to the CSI report.

Alternatively, the transmitting/receiving section 120 may transmit information related to a parameter to be applied to a report of encoded channel state information (CSI) to a terminal. The control section 110 may control reception of the report of the encoded CSI transmitted from the terminal, based on the information related to the parameter.

### (User Terminal)

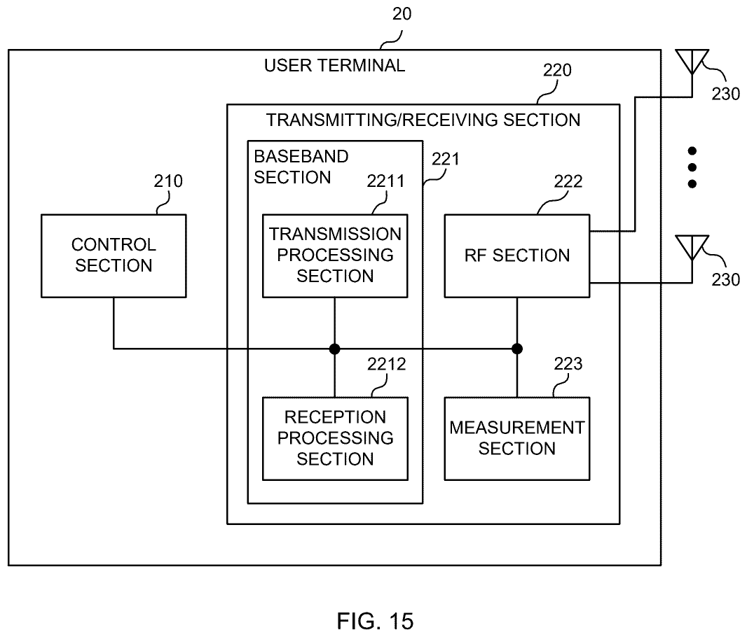

FIG. 15 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may receive information related to a channel state information (CSI) report indicating at least one of a report of encoded first CSI and a report of second CSI different from the first CSI. The control section 210 may determine CSI to be reported, based on the information related to the CSI report.

The information related to the CSI report may be included in a certain parameter among higher layer parameters related to a CSI report configuration. Alternatively, the information related to the CSI report may be included in a higher layer parameter related to a CSI trigger state. Alternatively, the information related to the CSI report may be included in at least one of downlink control information and a MAC CE.

The transmitting/receiving section 220 may receive information related to a parameter to be applied to a report of encoded channel state information (CSI). The control section 210 may control the report of the encoded CSI, based on the information related to the parameter.

When the information related to the parameter is configured for a CSI report, the control section 210 may control to perform the report of the encoded CSI.

The information related to the parameter may be included in at least one of a higher layer parameter related to a CSI report configuration, the higher layer parameter related to a CSI trigger state, downlink control information for triggering the report of the encoded CSI, and a MAC CE for activating the report of the encoded CSI.

The report of the encoded CSI may be supported in only at least one of a specific time domain behavior property and a specific uplink channel.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (separate apparatus), for example, via wire, wireless, or the like, and using these plurality of pieces of apparatus (these plurality of apparatus). The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

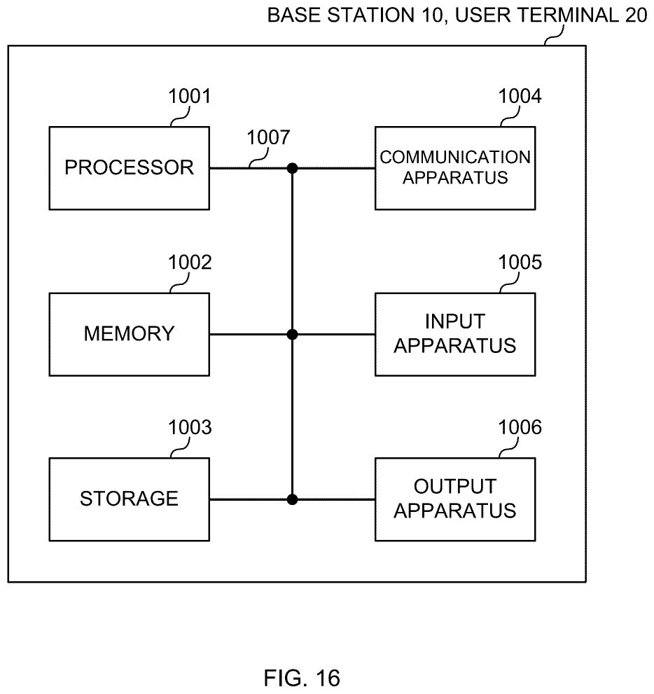

For example, a base station, a user terminal, and so on according to one embodiment of the present disclosure may function as a computer that executes the processes of the radio communication method of the present disclosure. FIG. 16 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus (between apparatus).

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware (these hardware).

### Variations

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

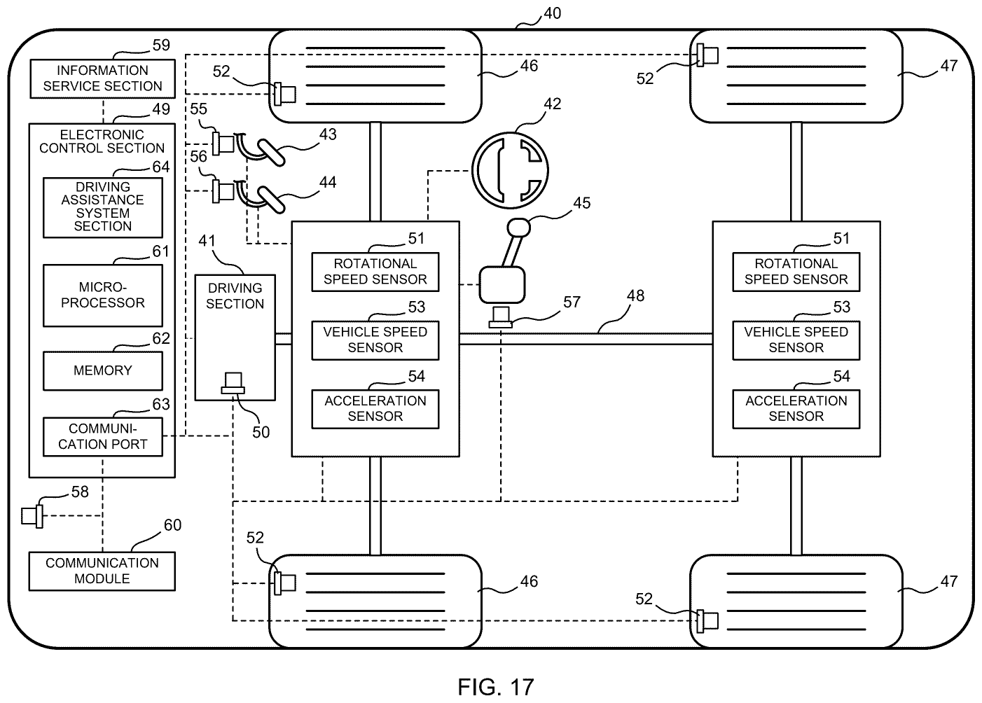

FIG. 17 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information (various information) such as drive information, traffic information, and entertainment information, such as a car navigation system, an audio system, a speaker, a display, a television, and a radio, and one or more ECUs that control these devices. The information service section 59 provides various pieces of information/services (various information/services), for example, multimedia information/multimedia service, for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUs that control these devices. The driving assistance system section 64 transmits and receives various pieces of information (various information) via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information (various information) to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (various information), for example, traffic information, signal information, inter-vehicle distance information, and the like, transmitted from the external apparatus, and displays the various pieces of information (various information) on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information (various information) received from the external apparatus in the memory 62 that can be used by the microprocessor 61. Based on the pieces of information (Based on the information) stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B are each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a receiving section that receives information related to a parameter to be applied to a report of encoded channel state information (CSI); and
a control section that controls the report of the encoded CSI, based on the information related to the parameter.

2. The terminal according to claim 1, wherein
when the information related to the parameter is configured for a CSI report, the control section controls to perform the report of the encoded CSI.

3. The terminal according to claim 1, wherein
the information related to the parameter is included in at least one of a higher layer parameter related to a CSI report configuration, the higher layer parameter related to a CSI trigger state, downlink control information for triggering the report of the encoded CSI, and a MAC CE for activating the report of the encoded CSI.

4. The terminal according to claim 1, wherein
the report of the encoded CSI is supported in only at least one of a specific time domain behavior property and a specific uplink channel.

5. A radio communication method for a terminal, the radio communication method comprising:
receiving information related to a parameter to be applied to a report of encoded channel state information (CSI); and
controlling the report of the encoded CSI, based on the information related to the parameter.

6. A base station comprising:
a transmitting section that transmits information related to a parameter to be applied to a report of encoded channel state information (CSI) to a terminal; and
a control section that controls reception of the report of the encoded CSI transmitted from the terminal based on the information related to the parameter.

7. The terminal according to claim 2, wherein
the information related to the parameter is included in at least one of a higher layer parameter related to a CSI report configuration, the higher layer parameter related to a CSI trigger state, downlink control information for triggering the report of the encoded CSI, and a MAC CE for activating the report of the encoded CSI.

8. The terminal according to claim 2, wherein
the report of the encoded CSI is supported in only at least one of a specific time domain behavior property and a specific uplink channel.

9. The terminal according to claim 3, wherein
the report of the encoded CSI is supported in only at least one of a specific time domain behavior property and a specific uplink channel.
